(19) United States
(12) Patent Application Publication
(10) Pub. No.: US 2021/0008864 A1
(43) Pub. Date: Jan. 14, 2021

(54) PEELING APPARATUS FOR ALUMINUM PLATE MATERIAL AND METHOD FOR PEELING ALUMINUM PLATE MATERIAL

(71) Applicants: FURUKAWA ELECTRIC CO., LTD., Tokyo (JP); UACJ CORPORATION, Tokyo (JP)

(72) Inventors: Toshihiro NAKAMURA, Tokyo (JP); Hideki TAKAHASHI, Tokyo (JP); Kimie IMAKAWA, Tokyo (JP); Naoki KITAMURA, Tokyo (JP); Kotaro KITAWAKI, Tokyo (JP); Takuya MURATA, Tokyo (JP)

(73) Assignees: FURUKAWA ELECTRIC CO., LTD., Tokyo (JP); UACJ CORPORATION, Tokyo (JP)

(21) Appl. No.: 17/035,467

(22) Filed: Sep. 28, 2020

Related U.S. Application Data
(63) Continuation of application No. PCT/JP2019/013087, filed on Mar. 27, 2019.

(30) Foreign Application Priority Data
Mar. 30, 2018 (JP) 2018-069344

(51) Int. Cl. B32B 43/00; B32B 15/01; B65H 1/04; B65H 3/62

(52) U.S. Cl. CPC B32B 43/006; B32B 15/016; B32B 2457/00; B65H 3/62; B65H 1/04

(57) ABSTRACT

A peeling apparatus for an aluminum plate material is configured to be able to peel one or a plurality of aluminum plate materials from a stack of aluminum plate materials in which a plurality of aluminum plate materials are pressure-annealed and adhered to each other. The peeling apparatus includes a vibration transmitting section that is configured to be able to abut an outer peripheral surface of an aluminum plate material and is configured to be able to apply vibration along a stacking direction of the stack to the aluminum plate material, and a transducer that generates the vibration, and transmits the vibration to the vibration transmitting section.

### CROSS REFERENCE TO RELATED APPLICATIONS

The present application is a continuation application of International Patent Application No. PCT/JP20191013087 filed on Mar. 27, 2019, which claims priority to Japanese Patent Application No. 2018-069344, filed on Mar. 30, 2018. The contents of these applications are incorporated herein by reference in their entirety.

### BACKGROUND

### Technical Field

The present disclosure relates to a peeling apparatus and a peeling method for an aluminum plate material that peel each aluminum plate material from a stack of aluminum plate materials in which a plurality of stacked aluminum plate materials are pressure-annealed and adhered to each other.

### Description of the Related Art

For example, for an aluminum plate material such as an aluminum substrate for magnetic disk, correction of flatness is performed by pressure annealing in order to secure flatness thereof. Correction treatment of flatness is performed in a state where a plurality of aluminum plate materials are stacked and pressurized, and after an end of pressure annealing, the aluminum plate materials are peeled from the stack of the aluminum plate materials one by one.

On the other hand, in the stack of the aluminum plate materials after the end of pressure annealing, the respective aluminum plate materials are closely adhered to each other. Even if the aluminum plate materials are tried to be peeled one by one from the stack of the aluminum plate materials after the end of pressure annealing, the aluminum plate material cannot be easily peeled by a human hand.

Thus, there is proposed a method for applying ultrasonic waves to an aluminum plate material in order to peel aluminum plate materials one by one from the stack of the aluminum plate materials that are pressure-annealed and are adhered to each other. For example, there is proposed a method for pealing single plates adhered to each other by vibration by giving ultrasonic vibration to a liquid in a state where a stack in which single plates such as blank materials are adhered to each other is immersed into the liquid (Japanese Patent Application Publication No. 03-288742).

Further, as another method for applying ultrasound waves, there is proposed a method for peeling aluminum disks that are adhered to each other by pressing a transducer with a tip end formed into a wedge portion entering a groove into the groove formed by chamfered portions of the aluminum disks adjacent in a state adhered to each other by pressure annealing, and giving ultrasonic vibration to the above described transducer.

### SUMMARY

However, in the art of Japanese Patent Application Publication No. 03-288742 described above, the aluminum plate materials are peeled via the liquid such as CFC-113 (Chlorofluorocarbon) as a medium for transmitting ultrasonic vibration, so that an immersion step, and a drying step or the like for the aluminum plate materials are required, and there arises the problem that the steps for peeling treatment are complicated. Further, because waste liquid treatment for treating a used liquid is required, complicated treatment is involved, and an environmental load is also large. Furthermore, it is necessary to install respective apparatuses for carrying out the immersion step and the drying step for the aluminum plate materials, so that the apparatus configuration is complicated, and an installation space is limited. Further, all of the aluminum plate materials in a tank are peeled substantially simultaneously, so that there has been the fear that the aluminum plate materials contact one another in the tank and scars occur to the surfaces.

Further, in the art of Japanese Patent Application Publication No. 62-278254 described above, a pair of transducers each in a semi-arc-shape are disposed to sandwich the aluminum plate material from both sides thereof, and ultrasonic vibration is applied to the above described pair of transducers, so that when outside diameters of the aluminum plate materials are changed with change of specifications or the like, a pair of transducers have to be replaced at each time of the change, which is troublesome. Further, the direction of the ultrasonic vibration is a direction parallel with the surface of the substrate, so that there has been the fear that the aluminum plate materials after peeled rub against each other and scratch the surfaces. Further, since the entire wedge portions of the pair of transducers are inserted in the groove formed in the outer peripheral portion of the flattened aluminum plate material, the entire wedge portion needs to be formed on the substantially same plane, so that dimensional accuracy is required and the entire wedge portion cannot be inserted in the groove when a dimensional change occurs due to a secular change, and therefore it cannot be said that the aluminum plate materials can be sufficiently peeled. Especially in recent years, along with the increase in capacity of magnetic disks, aluminum plate materials have become thinner, further flattening has been required, and in the interface between the aluminum plate materials that are further flattened, the adhesive force increases, so that more reliable peeling of the aluminum plate materials as compared with the conventional peeling is required.

The present disclosure provides a peeling apparatus for an aluminum plate material and a method for peeling an aluminum plate material that can simplify treatment steps and an apparatus configuration, can easily and reliably peel an aluminum plate material from a stack and do not easily scratch a surface of a substrate, even when the aluminum plate material is made thin or highly flattened, and when an outside diameters of the aluminum plate material is changed, and has an extremely small environmental load and a high degree of freedom in implementation environment.

[1] A peeling apparatus for an aluminum plate material configured to be able to peel one or a plurality of aluminum plate materials from a stack of aluminum plate materials in which a plurality of aluminum plate materials are pressure-annealed and adhered to each other, comprising:

a vibration transmitting section that is configured to be able to abut an outer peripheral surface of the aluminum plate material, and is configured to be able to apply vibration along a stacking direction of the stack to the aluminum plate material; and

a transducer that is connected to the vibration transmitting section, generates the vibration, and transmits the vibration to the vibration transmitting section.

[2] The peeling apparatus for an aluminum plate material according to the above described [1], further comprising a moving mechanism configured to be able to relatively move the vibration transmitting section and the aluminum plate material.

[3] The peeling apparatus for an aluminum plate material according to the above described [1], wherein the vibration transmitting section abuts on a position that is 50 μm or more from an end surface in a plate thickness direction of the aluminum plate material toward a plate thickness center side, of the outer peripheral surface of the aluminum plate material.

[4] The peeling apparatus for an aluminum plate material according to the above described [3], wherein

in the stack, the plurality of aluminum plate materials are disposed by being stacked along a vertical direction; and

the vibration transmitting section abuts on a position that is 50 μm or more from an upper end surface in a plate thickness direction of the aluminum plate material toward a plate thickness center side and is upward of a center position in the plate thickness direction of the aluminum plate material, of the outer peripheral surface of the aluminum plate material.

[5] The peeling apparatus for an aluminum plate material according to the above described [1], wherein the vibration transmitting section abuts the outer peripheral surface of a single aluminum plate material located at an outermost portion of the stack.

[6] A method for peeling an aluminum plate material for peeling one or a plurality of aluminum plate materials from a stack of aluminum plate materials in which a plurality of aluminum plate materials are pressure-annealed and adhered to each other, comprising

applying vibration along a stacking direction of the stack, to an outer peripheral surface of the aluminum plate material.

[7] The method for peeling an aluminum plate material according to the above described [6], wherein the vibration is applied to a position that is 50 μm or more from an end surface in a plate thickness direction of the aluminum plate material toward a plate thickness center side, of the outer peripheral surface of the aluminum plate material.

[8] The method for peeling an aluminum plate material according to the above described [7], wherein

in the stack, the plurality of aluminum plate materials are disposed by being stacked along a vertical direction; and

the vibration is applied to a position that is 50 μm or more from an end surface at a plate thickness direction side of the aluminum plate material toward the plate thickness center side and is upward of a center position in the plate thickness direction of the aluminum plate material, of the outer peripheral surface of the aluminum plate material.

[9] The method for peeling an aluminum plate material according to the above described [6], wherein the vibration is applied to the outer peripheral surface of a single aluminum plate material located at an outermost portion of the stack.

According to the present disclosure, the vibration along the stacking direction of the stack is applied to the outer peripheral surface of the aluminum plate material, so that even when the aluminum plate material is made thin or highly flattened, or even when the outside diameter of the aluminum plate material is changed, it is possible to easily generate a sufficient peeling force to separate the aluminum plate material and the stack on the interface between the aluminum plate material and the stack, and it is possible to reliably peel one or a plurality of aluminum plate materials from the stack. Further, immersion and drying of the aluminum plate material is unrequired, so that the steps for peeling treatment are simplified, and the waste liquid treatment for treating a used liquid is also unrequired, so that troublesome treatment is not involved, and an environmental load is extremely small. Further, the transducer only has to have a structure and a shape capable of abutting the outer peripheral surface of the aluminum plate material, and another special device or the like is not required, so that it is possible to simplify the apparatus configuration, and increase the degree of freedom in an implementation environment.

Furthermore, since the direction of the ultrasonic vibration after peeling is a direction to peel the main surface of the substrate, the surface is hardly scratched.

### BRIEF DESCRIPTION OF DRAWINGS

FIGS. 1A and 1B A view of an embodiment of the present disclosure schematically illustrating a configuration of a peeling apparatus for an aluminum plate material.

FIGS. 2A to 2C are views for explaining a method for peeling an aluminum plate material according to the embodiment of the present disclosure.

FIGS. 3A to 3B are views for explaining modified examples of the method for peeling an aluminum plate material in FIGS. 2A to 2C.

### DESCRIPTION OF EMBODIMENTS

Hereinafter, embodiments of the present disclosure will be described while referring to the drawings.

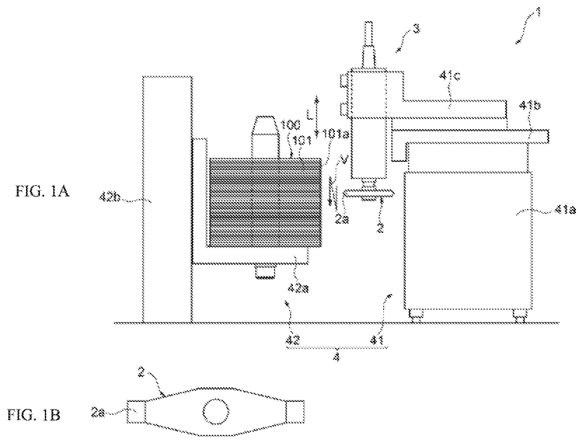

FIGS. 1A and 1B illustrate a configuration of a peeling apparatus for an aluminum plate material according to the present embodiment, FIG. 1A illustrates an entire view of the peeling apparatus for an aluminum plate material, and FIG. 1B illustrates a plan view of a vibration transmitting section 2 described later. Note that FIGS. 1A and 1B illustrate one example of the configuration of the peeling apparatus for an aluminum plate material, and a configuration of the peeling apparatus for an aluminum plate material of the present disclosure is not limited to the configuration illustrated in FIGS. 1A and 1B.

As illustrated in FIGS. 1A and 1B, a peeling apparatus 1 for an aluminum plate material is configured to be able to peel one or a plurality of aluminum plate materials from a stack 100 of aluminum plate materials in which a plurality of aluminum plate materials 101, 101, . . . are pressure-annealed and are adhered to each other. Specifically, the peeling apparatus 1 for an aluminum plate material includes the vibration transmitting section 2 configured to be able to abut an outer peripheral surface 101a of the aluminum plate material 101, and configured to be able to apply vibration V to the aluminum plate material 101 along a stacking direction L of the stack 100, and a transducer 3 that is connected to the vibration transmitting section 2, generates the vibration V and transmits the vibration V to the vibration transmitting section 2.

Further, the peeling apparatus 1 includes a moving mechanism 4 configured to be able to relatively move the vibration transmitting section 2 and the aluminum plate material 101. The moving mechanism 4 includes a first moving device 41 configured to be able to move the vibration transmitting section 2 with respect to the outer peripheral surface 101a of the aluminum plate material 101. The first moving device 41 includes, for example, a casing 41a, a cylinder 41b that is fixed to the casing 41a, and extends and contracts in a direction perpendicular to the stacking direction L, and a support section 41c that is fixed to the cylinder 41b and supports the transducer 3. The vibration transmitting section 2 is moved in the direction perpendicular to the stacking direction L by extension and contraction of the cylinder 41b, and the vibration transmitting section 2 is abutted or pressed onto the outer peripheral surface 101a of the aluminum plate material 101, whereby the vibration V of the vibration transmitting section 2 is applied to the aluminum plate material 101. When a single aluminum plate material is to be peeled from the stack 100, the vibration transmitting section 2 is abutted onto the outer peripheral surface 101a of the single aluminum plate material 101 located at an outermost portion (uppermost portion) of the stack 100.

Further, the moving mechanism 4 includes a second moving device 42 configured to be able to move the aluminum plate material 101 with respect to the vibration transmitting section 2. The second moving device 42 includes, for example, a holding section 42a that holds the aluminum plate materials 101 or the stack 100, and an actuator 42b configured to be able to move the aluminum plate material 101 held by the holding section 42a with respect to the vibration transmitting section 2. The actuator 42b is configured to be able to move the holding section 42a in the stacking direction L.

In this way, in the moving mechanism 4, the first moving device 41 and the second moving device 42 cooperate to enable the vibration transmitting section 2 to abut at an arbitrary position of the outer peripheral surface 101a of the aluminum plate material 101.

The vibration transmitting section 2 is a long member having an end portion 2a, for example, and the end portion 2a abuts the outer peripheral surface 101a of the aluminum plate material 101 when the vibration transmitting section 2 applies the vibration V to the aluminum plate material 101. It is preferable that the end portion 2a is a protruded portion having a curved surface bulging toward an outer peripheral surface 101a side, from a viewpoint of preventing the end portion 2a from scratching the outer peripheral surface 101a of the aluminum plate material 101.

The vibration V of the transducer 3 is not specially limited, but, for example, is vibration of several thousand times/minute or less, high-speed minute vibration (20 to 20 kHz) in a sound wave region, or ultrasonic vibration (over 20 kHz). Further, in the case of high-speed minute vibration in the sound wave region or ultrasonic vibration, an output thereof is, for example, 100 W or more and 300 W or less.

A configuration of the transducer 3 is not limited as long as the transducer 3 can generate the vibration V along the stacking direction L of the stack 100, on the aluminum plate material 101, but includes, for example, a drive motor, or an oscillator that generates sound waves or ultrasonic waves. Further, the transducer 3 is connected to the vibration transmitting section 2 via a connection member, and is configured to be able to transmit vibration generated in the transducer 3 directly to the vibration transmitting section 2.

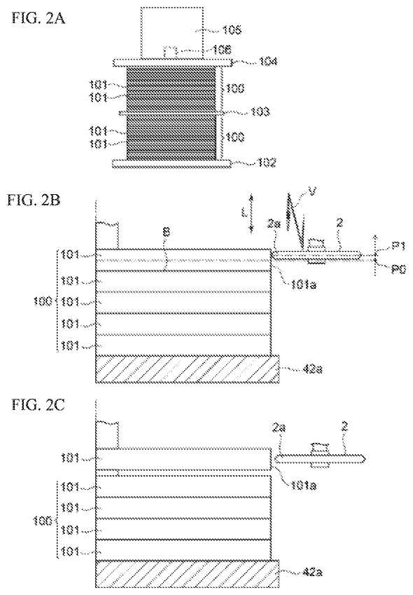

FIGS. 2A to 2C are views for explaining a method for peeling an aluminum plate material according to the embodiment of the present disclosure. The method for peeling an aluminum plate material explained by FIGS. 2A to 2C is executed by the peeling apparatus 1 for an aluminum plate material in FIGS. 1A and 1B, for example. However, the method for peeling an aluminum plate material explained in FIGS. 2A to 2C only illustrates one example thereof, and the method for a peeling aluminum plate material of the present disclosure is not limited to the method illustrated in FIGS. 1A and 1B.

First, as illustrated in FIG. 2A, a plurality of aluminum plate materials 101, 101, . . . are stacked in a predetermined number on a lower surface plate 102 to form the stack 100, the stack 100 is further formed via a partition plate 103, an upper surface plate 104 and a weight 105 are placed thereon to press the stacks 100 and 100. The aluminum plate material 101 includes a through-hole formed in a center portion in a radial direction thereof, and a shaft member 106 fixed to the lower surface plate 102 is inserted through the above described through-hole, whereby the plurality of aluminum plate materials 101, 101, . . . forming the stack 100 are disposed concentrically. Annealing is performed for the stacks 100 and 100 in this state (pressure annealing), and thereby the aluminum plate materials 101 and 101 adjacent in the respective stacks are brought into a state adhering to each other.

Next, as illustrated in FIG. 2B, when one or a plurality of aluminum plate materials 101 is or are to be peeled from the stack 100 of aluminum plate materials in which a plurality of aluminum plate materials 101, 101, are pressure-annealed and adhered to each other, the stack 100 is held on the holding section 42a, and the vibration V along the stacking direction L of the stack 100 is applied to the outer peripheral surface 101a of the aluminum plate material 101. In the present embodiment, the end portion 2a of the vibration transmitting section 2 is abutted onto the outer peripheral surface 101a of the aluminum plate material 101, and thereby the vibration V is applied to the outer peripheral surface 101a of the aluminum plate material 101.

At this time, it is preferable that the vibration transmitting section 2 abuts on a position of 50 μm (micrometers) or more from an end surface (main surface of the aluminum plate material) in a plate thickness direction of the aluminum plate material 101 toward a plate thickness center side, of the outer peripheral surface 101a of the aluminum plate material 101. Specifically, it is preferable to apply the vibration. V onto the position that is 50 μm or more from the end surface in the plate thickness direction of the aluminum plate material 101 toward the plate thickness center side, of the outer peripheral surface 101a of the aluminum plate material 101. Further, when the thickness of the aluminum plate material 101 is larger than 100 μm, it is preferable that the vibration transmitting section 2 abuts on the position that is 50 μm or more from both of one end surface (main surface) in the plate thickness direction of the aluminum plate material 101 and the other end surface (main surface) toward the plate thickness center side, of the outer peripheral surface 101a of the aluminum plate material 101.

For example, as illustrated in FIG. 2B, when a plurality of aluminum plate materials 101, 101, . . . are disposed by being stacked along a vertical direction, the vibration transmitting section 2 can abut on a position P1 that is or more from an upper end surface in the plate thickness direction of the aluminum plate material 101 toward the plate thickness center side, and is upward of a center position P0 in the plate thickness direction of the aluminum plate material 101, of the outer peripheral surface 101a of the aluminum plate material 101. Specifically, the vibration V is applied to the position P1 that is 50 μm or more from the upper end surface in the plate thickness direction of the aluminum plate material 101 toward the plate thickness center side, and is upward of the center position P0 in the plate thickness direction of the aluminum plate material 101, of the outer peripheral surface 101a of the aluminum plate material 101. Thereby, distances between the position P1 to which the vibration V is applied, and an interface B between the adjacent aluminum plate materials 101 and 101 that are peeling targets, or an uppermost surface of the aluminum plate material 101 become large, and the vibration does not escape, so that it becomes possible to generate a larger peeling force on the interface B.

In the present embodiment, for example, a single aluminum plate material is peeled from the stack 100. In this case, the vibration transmitting section 2 abuts the outer peripheral surface 101a of the single aluminum plate material 101 located at an outermost portion of the stack 100. For example, as illustrated in FIG. 2B, when the stack 100 is such that the plurality of aluminum plate materials 101, 101, . . . are disposed by being stacked along the vertical direction, the vibration transmitting section 2 abuts the outer peripheral surface 101a of the single aluminum plate material 101 located at the uppermost portion of the stack 100. Specifically, the vibration V is applied to the outer peripheral surface 101a of the single aluminum plate material 101 located at the uppermost portion of the stack 100.

However, not only the single aluminum plate material is peeled from the stack 100, but also a plurality of aluminum plate materials 101, 101, . . . may be peeled from the stack 100. In this case, the vibration transmitting section 2 abuts the outer peripheral surface 101a of the aluminum plate material 101 other than the aluminum plate material 101 located at the outermost portion (for example, the uppermost portion) of the stack 100.

By application of the above described vibration V to the aluminum plate material 101, the aluminum plate material 101 is peeled from the stack 100. For example, when the vibration transmitting section 2 abuts the outer peripheral surface 101a of the single aluminum plate material 101 located at the uppermost portion of the stack 100 and the vibration V is applied, the single aluminum plate material 101 located at the uppermost portion of the stack 100 is peeled as illustrated in FIG. 2C. Further, when the vibration transmitting section 2 abuts the outer peripheral surface 101a of the aluminum plate material 101 other than the aluminum plate material 101 located at the outermost portion (for example, the uppermost portion) of the stack 100 and the vibration V is applied, a plurality of aluminum plate materials 101, 101, . . . located at an outer side (for example, an upper side) of the stack 100 are peeled in bulk.

Subsequently, by repeating operations illustrated in FIG. 2B and FIG. 2C, the aluminum plate materials 101 are sequentially peeled from the stack 100 in a unit of one sheet or in bulk.

As described above, according to the present embodiment, the vibration transmitting section 2 is configured to be able to abut the outer peripheral surface 101a of the aluminum plate material 101 and is configured to be able to apply the vibration V along the stacking direction of the stack 100 to the aluminum plate material 101, and applies the vibration V along the stacking direction L of the stack 100 to the outer peripheral surface 101a of the aluminum plate material 101, so that even when the aluminum plate material 101 is made thin or is highly flattened, or the outside diameter of the aluminum plate material 101 is changed, it is possible to easily generate a sufficient peeling force to separate the aluminum plate material 101 and the stack 100 on the interface B between the aluminum plate material 101 and the stack 100, and it is possible to reliably peel one or a plurality of aluminum plate materials 101 from the stack 100. Further, immersion and drying of the aluminum plate material 101 are unrequired, so that the steps for peeling treatment are simplified, and the waste liquid treatment of treating a used liquid is also unrequired, so that troublesome treatment is not involved, and an environmental load is extremely, small. Further, the vibration transmitting section 2 only has to have a structure and a shape capable of abutting the outer peripheral surface 101a of the aluminum plate material 101, and another special device or the like is not required, so that it is possible to simplify the apparatus configuration, and it is possible to increase the degree of freedom in an implementation environment.

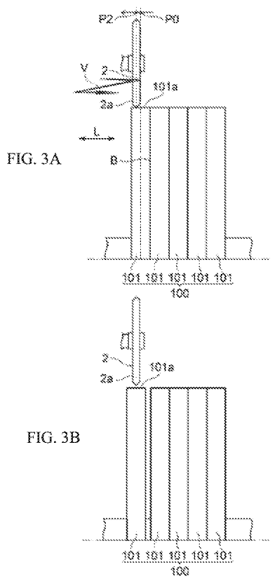

In FIGS. 2A to 2C, the vibration V is applied to the position P1 that is 50 μm or more from the upper end surface in the plate thickness direction of the aluminum plate material 101 toward the plate thickness center side, of the outer peripheral surface 101a of the aluminum plate material 101, and is upward of the center position in the plate thickness direction of the aluminum plate material 101, but the present disclosure is not limited to this. For example, as illustrated in FIG. 3A, even when a plurality of aluminum plate materials 101, 101, . . . are disposed by being stacked along a horizontal direction, it is possible to apply the vibration V to the outer peripheral surface 101a of the aluminum plate material 101 by abutting the end portion 2a of the vibration transmitting section 2 to the outer peripheral surface 101a of the aluminum plate material 101, as in the case illustrated in FIGS. 2A to 2C.

At this time, it is possible to apply the vibration V to a position that is 50 μm or more from an end surface in a plate thickness direction toward a plate thickness center side, of the outer peripheral surface 101a of the aluminum plate material 101. It is preferable to apply the vibration V to a position P2 that is a position that is 50 μm or more from the end surface in the plate thickness direction toward the plate thickness center side, and is deviated sideward to an opposite side to the stack 100 from the center position P0 in the plate thickness direction of the aluminum plate material 101. Thereby, a distance from the interface B between the adjacent aluminum plate materials 101 and 101 that are peeling targets becomes large, and it becomes possible to generate a greater peeling force on the interface B.

Further, in FIG. 3A, the single aluminum plate material is peeled from the stack 100, but the present disclosure is not limited to this, and a plurality of aluminum plate materials 101, 101, . . . may be peeled from the stack 100.

Even when the stacking direction L of the stack 100 is the direction along the horizontal direction in this way, it becomes possible to peel the aluminum plate materials 101 sequentially from the stack 100 in the unit of one sheet or in bulk, as illustrated in FIG. 3B.

In the present disclosure, it is possible to peel the aluminum plate materials from the stack of the aluminum plate materials in which a plurality of aluminum plate materials are pressure-annealed and adhered to each other, in the unit of one sheet or in bulk, so that the present disclosure has high utility value in the field of peeling aluminum substrates for magnetic disk a stack of which is pressure-annealed to ensure flatness, from the stack.

1. A peeling apparatus for an aluminum plate material configured to be able to peel one or a plurality of aluminum plate materials from a stack of aluminum plate materials in which a plurality of aluminum plate materials are pressure-annealed and adhered to each other, comprising:
a vibration transmitting section that is configured to be able to abut an outer peripheral surface of the aluminum plate material, and is configured to be able to apply vibration along a stacking direction of the stack to the aluminum plate material; and
a transducer that is connected to the vibration transmitting section, generates the vibration, and transmits the vibration to the vibration transmitting section.

2. The peeling apparatus for an aluminum plate material according to claim 1, further comprising a moving mechanism configured to be able to relatively move the vibration transmitting section and the aluminum plate material.

3. The peeling apparatus for an aluminum plate material according to claim 1, wherein the vibration transmitting section abuts on a position that is 50 μm or more from an end surface in a plate thickness direction of the aluminum plate material toward a plate thickness center side, of the outer peripheral surface of the aluminum plate material.

4. The peeling apparatus for an aluminum plate material according to claim 3, wherein
in the stack, the plurality of aluminum plate materials are disposed by being stacked along a vertical direction; and
the vibration transmitting section abuts on a position that is 50 μm or more from an upper end surface in a plate thickness direction of the aluminum plate material toward a plate thickness center side and is upward of a center position in the plate thickness direction of the aluminum plate material, of the outer peripheral surface of the aluminum plate material.

5. The peeling apparatus for an aluminum plate material according to claim 1, wherein the vibration transmitting section abuts the outer peripheral surface of a single aluminum plate material located at an outermost portion of the stack.

6. A method for peeling an aluminum plate material for peeling one or a plurality of aluminum plate materials from a stack of aluminum plate materials in which a plurality of aluminum plate materials are pressure-annealed and adhered to each other, comprising
applying vibration along a stacking direction of the stack, to an outer peripheral surface of the aluminum plate material.

7. The method for peeling an aluminum plate material according to claim 6, wherein the vibration is applied to a position that is 50 μm or more from an end surface in a plate thickness direction of the aluminum plate material toward a plate thickness center side, of the outer peripheral surface of the aluminum plate material.

8. The method for peeling an aluminum plate material according to claim 7, wherein
in the stack, the plurality of aluminum plate materials are disposed by being stacked along a vertical direction; and
the vibration is applied to a position that is 50 μm or more from an end surface at a plate thickness direction side of the aluminum plate material toward the plate thickness center side and is upward of a center position in the plate thickness direction of the aluminum plate material, of the outer peripheral surface of the aluminum plate material.

9. The method for peeling an aluminum plate material according to claim 6, wherein the vibration is applied to the outer peripheral surface of a single aluminum plate material located at an outermost portion of the stack.
